(19) United States
(12) Patent Application Publication
(10) Pub. No.: US 2008/0124065 A1
(43) Pub. Date: May 29, 2008

(54) Automatic picture and text alerting camera, with inbuilt smoke and motion detectors

(76) Inventor: Ahamefula Chukwu, Houston, TX (US)

Correspondence Address: CHUKWU AHAMEFULA, APT 2706, 9707 SOUTH GEGNER, HOUSTON, TX, 77071, US

(21) Appl. No.: 11/606,239

(22) Filed: Nov. 29, 2006

(51) Int. Cl. G03B 17/00

(52) U.S. Cl. 396/56

(57) ABSTRACT

This invention is more particular to a camera that is fully equipped with an inbuilt motion and smoke detector. The camera is specially design to be set by the user to capture any emergency condition detected by any of the said inbuilt detectors, it and automatically send picture or pictures of the emergency along with a written text massage merge to the picture at the top, bottom, side or middle of the picture, the text message states the exact emergency which can be fire or intrusion and also the address of the emergency. This information is sent by the camera to one or more programmed cellular telephone (number), that can receive the picture and text message by means of any available telecommunication network. The picture sent by the camera can be a still picture or a motion picture.

### BACKGROUND OF THE INVENTION

1. Field of Invention

The present invention relate to a camera security system, and more particular to a network security camera, that is easily programmed by the user to disclose the exact location of an emergency by sending picture of the emergency, and some text message merge with the picture to any programmed cellular telephone (number), that can receive the picture and the text message. The text message merge with the picture tells the location/address at an advent of the following emergency conditions smoke/fire or intrusion, this is achieve by the camera by means of any available telecommunication network, the picture sent by the camera can be a still picture or a motion picture.

This invention is more particular to a network camera that is fully equip with an inbuilt motion and smoke detector. The camera is specially design to capture any emergency condition detected by any of the said inbuilt detectors, and automatically send the picture of the emergency along with some text massage merge to the picture stating the address of the emergency, this information is sent by the camera to one or more program wireless cellular telephone (number) that can receive the picture and the text massage.

### SUMMARY OF THE INVENTION

The present invention is more particular to a security camera that has an inbuilt smoke and motion detector. The camera has the ability to send pictures of an emergency and some written text massage stating the exact location or address of the emergency. The picture and the text message are sent out in the same time to any program cellular telephone (number). The camera also comes with an external remote control. The remote control is specially designed for operating the camera. The remote control acts as a transceiver by sending and receiving data (program) to and from the camera. The camera is programmed originally by the manufacturer to disclose emergency condition example fire or intrusion through text message, stating the emergency which can be fire or intrusion, at the top, bottom or side, of the emergency picture sent to any receiving cellular telephone. While the remote control is specially designed for the user, for operating the camera and for entering the address or location were the camera will be install around the premises. When any emergency condition is detected by any of the detectors in the camera, the exact picture of the emergency condition and some text message stating the emergency, and the text message that was enter by the user stating the location or address of the emergency is automatically sent by the camera to any programmed cellular telephone number. The user using the remote control originally entered the location of the camera. The program cellular telephone number can be any preferred emergency responding party e.g. the police cellular telephone number, fire service cellular telephone number, or any other emergency responding party cellular telephone number. The user can also program his or her cellular telephone number for self-automatic emergency picture and text alert sent automatically by the camera by means of any available telecommunication network. One or more telecommunication company can serve as the automatic picture and text alerting camera service provider, because the camera works by connecting to one or more telecommunication network.

The address or location of the camera entered by the user using some set of buttons in the remote control can be erase and a new address or location of the camera can be enter or key in by the user, this is in case the user decide to change the location of the camera.

The camera also has an inbuilt alarm that can be set to sound when emergency condition is detected by the inbuilt detector (s), The alarm can also be set to sound only when smoke or fire is detected, it can also be put off completely, all the operations can be set by the user using the remote control.

The remote control have some set of buttons label 0 to 9 they are use for entry cellular telephone number, and they are also use for entering the address or location of the camera, other functions of the 0 to 9 buttons include password entry. The remote control also have a power on/off button, a select button, a shift space bar button and an enter button. With the use of all this set of buttons, the camera can be program by the user to function in the operation described in this invention.

The remote control displays some programs downloaded by a microcontroller in the remote control, the microcontroller download the programs from the camera, and the programs are displayed on a liquid crystal display in the remote. Here are listed names illustrating the programs; (1) Enter camera location or address, (2) Set intruder alert, (3) Set fire alert, (4) Enter numbers of alerts you want, (5) Set activation or deactivation menu, (6) Alarm on/off menu, (7) Password change menu, utilizing the key in buttons in the remote control and the program select, the enter button, and the shift button, the camera can be programmed by the user to function in the operation describe in this invention.

For more understanding of the nature and objective of the present invention, reference should be made to the following steps taken in conjunction with the accompanying drawings.

### BRIEF DESCRIPTION OF THE DRAWINGS

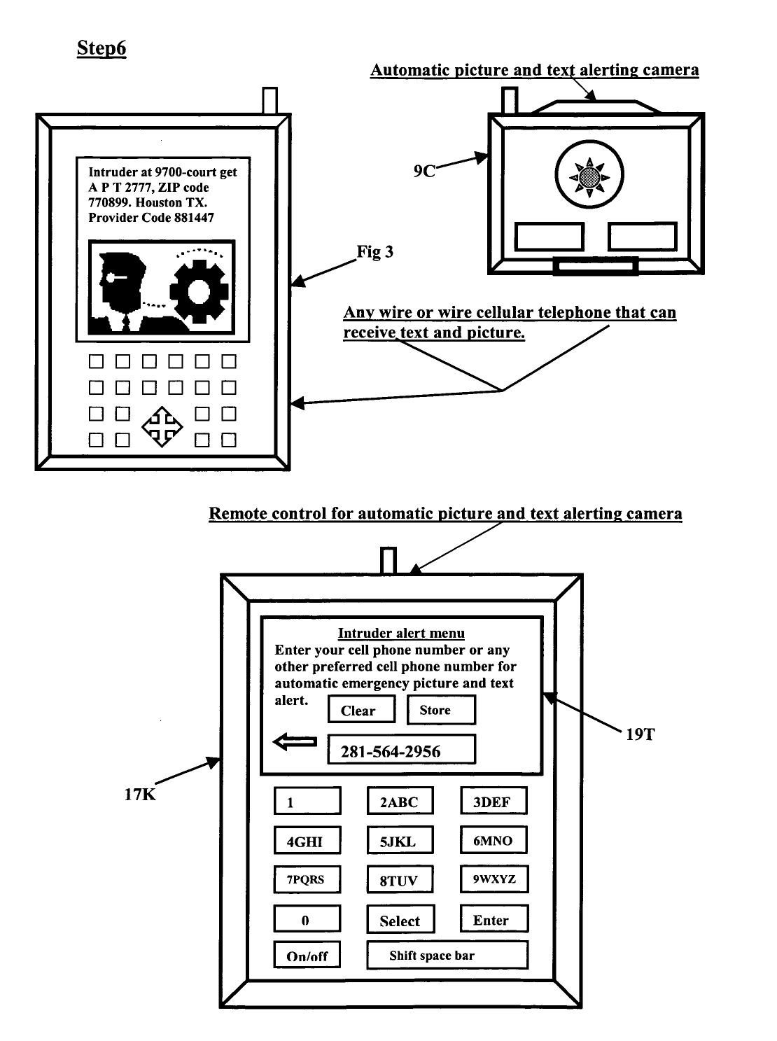

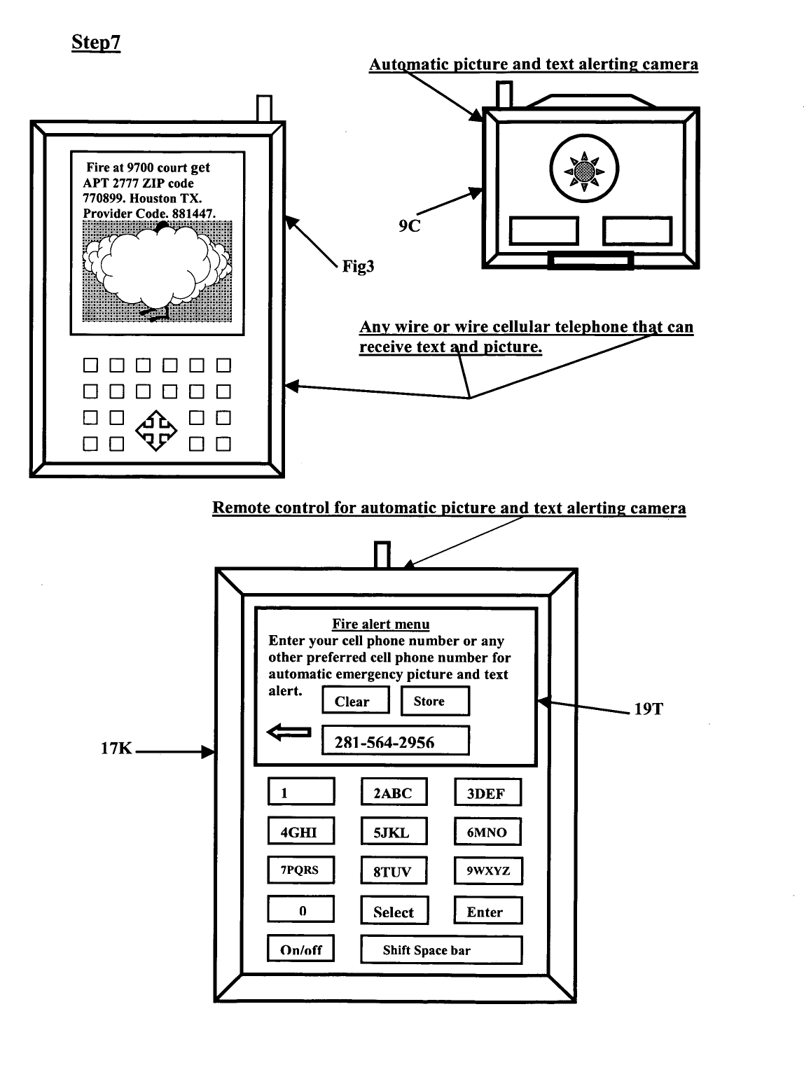

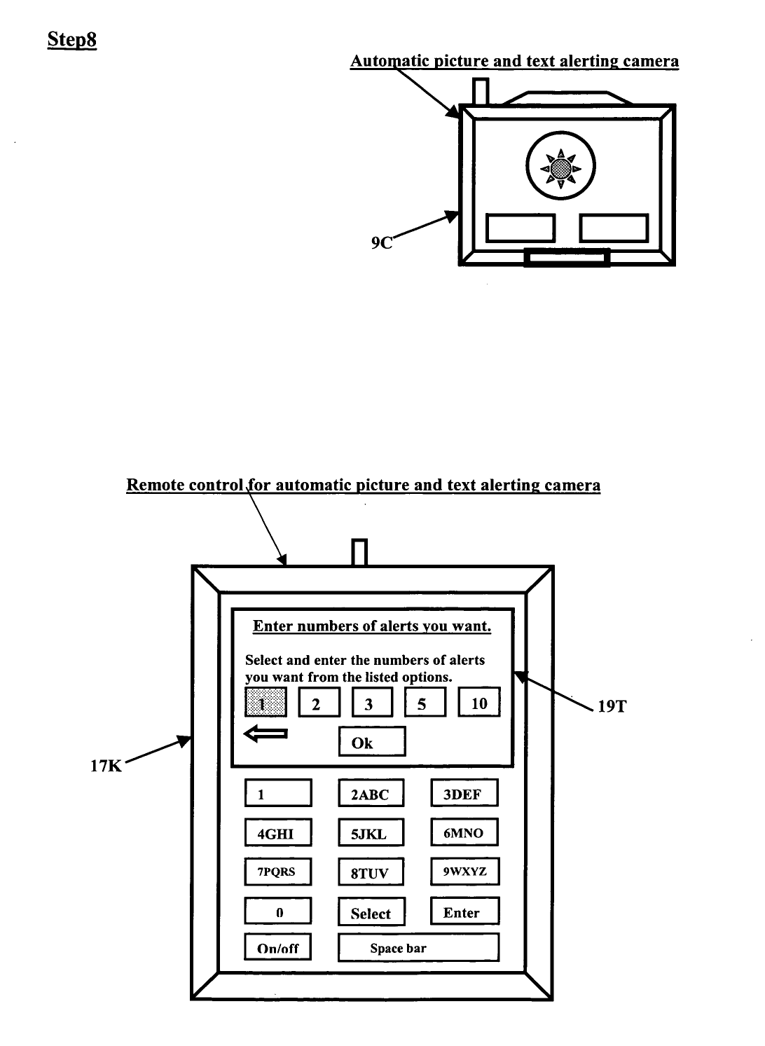

1, Step 1 to 11 describes embodiment of the camera and the remote control and the program generated by the camera as downloaded by the remote control and the method of operating the camera to send emergency picture with text message to any wireless cellular telephone that can receive picture and text message as shown in FIG. 3.

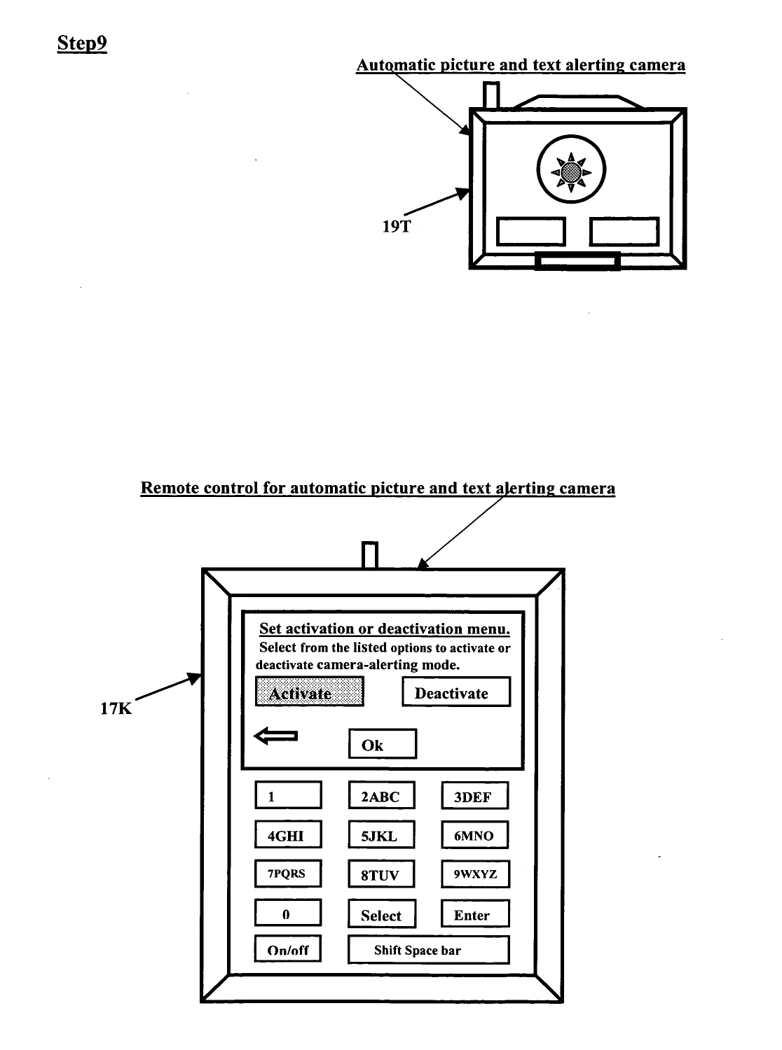

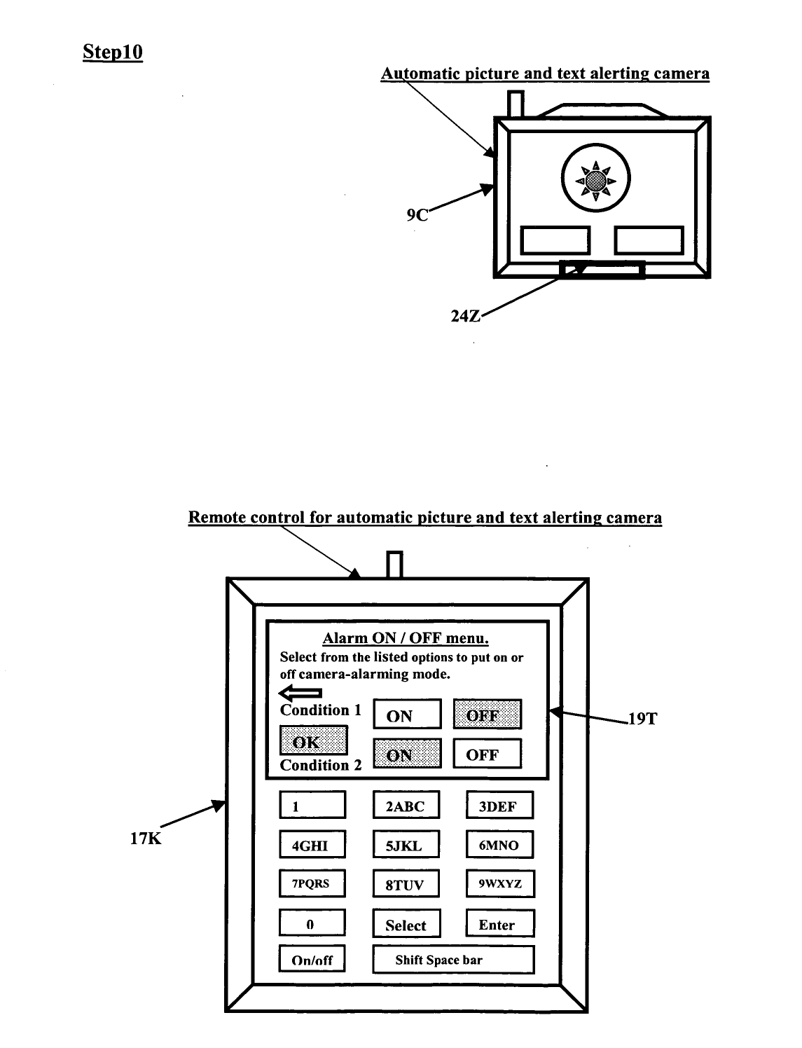

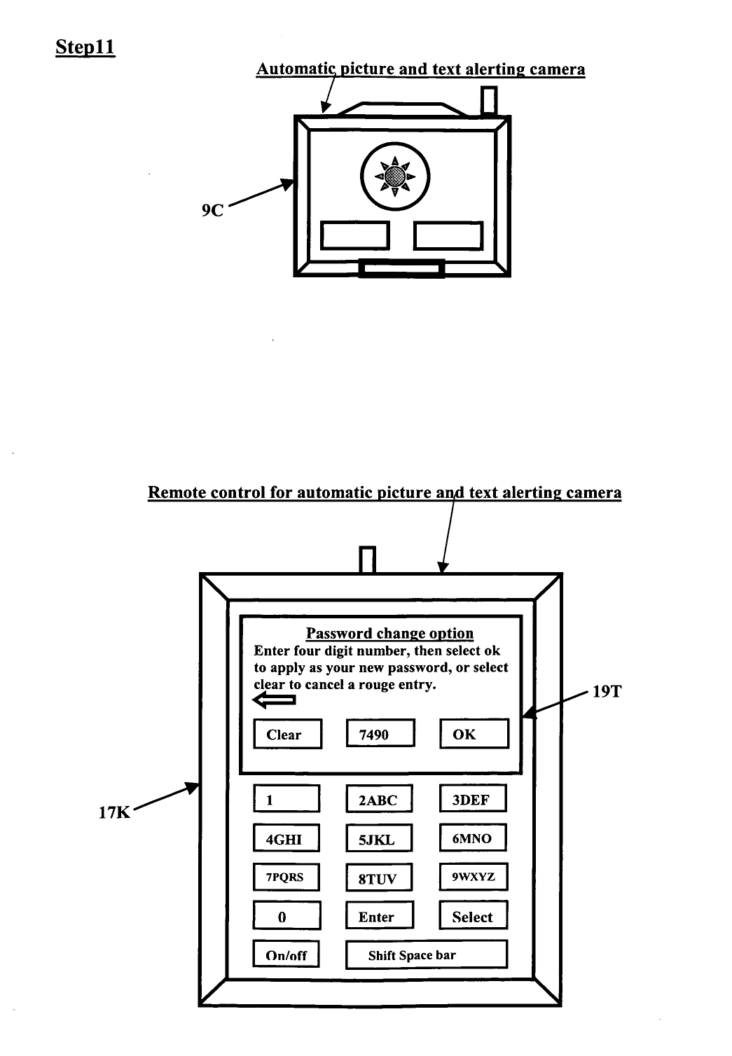

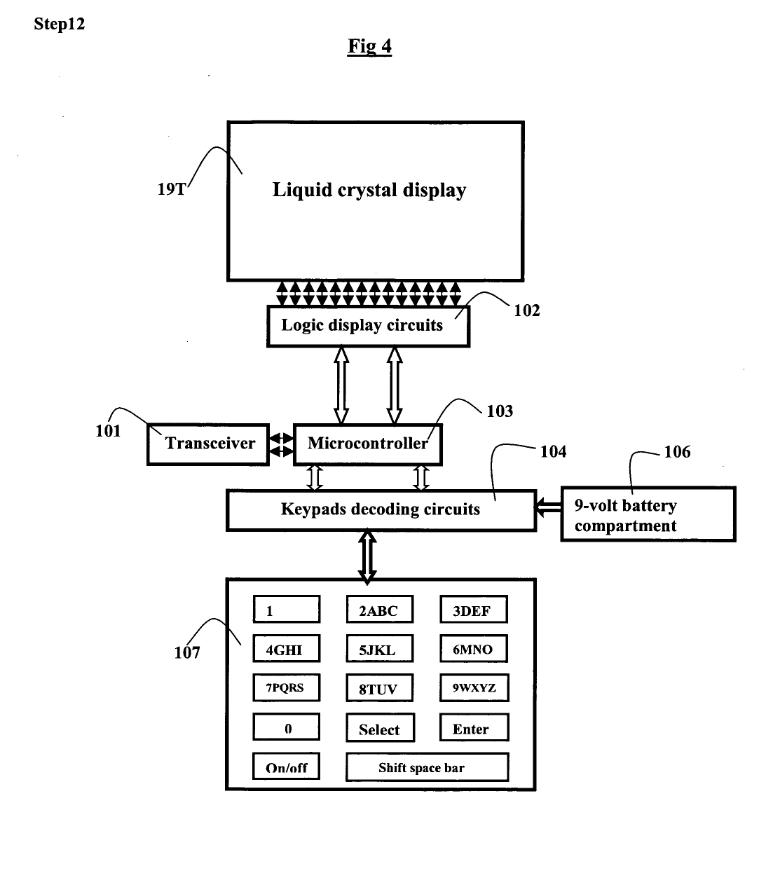

2, Step 12 shows FIG. 4 the electronic block diagram of the remote control.

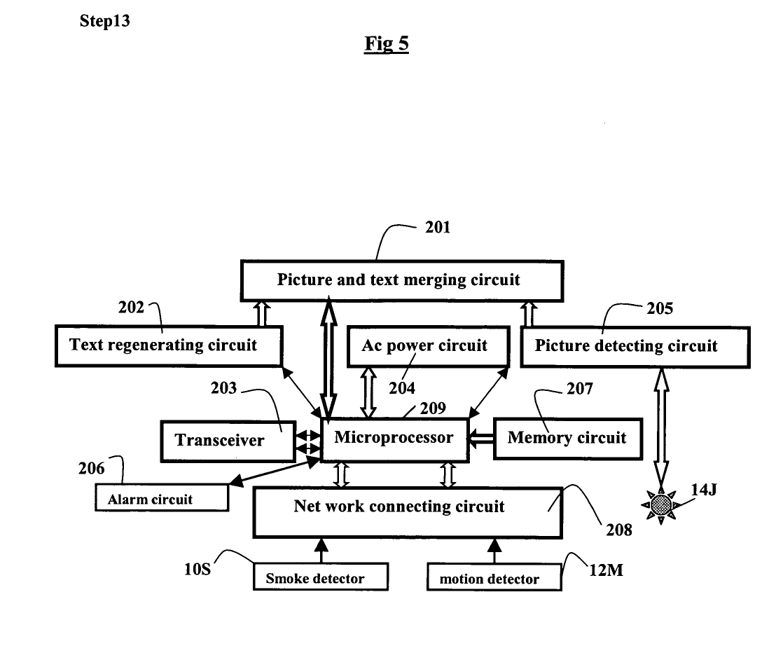

3, Step 13 shows FIG. 5 the electronic block diagram of the automatic picture and text-alerting camera.

### DETAILED DESCRIPTION OF THE PREFERRED EMBODIMENT

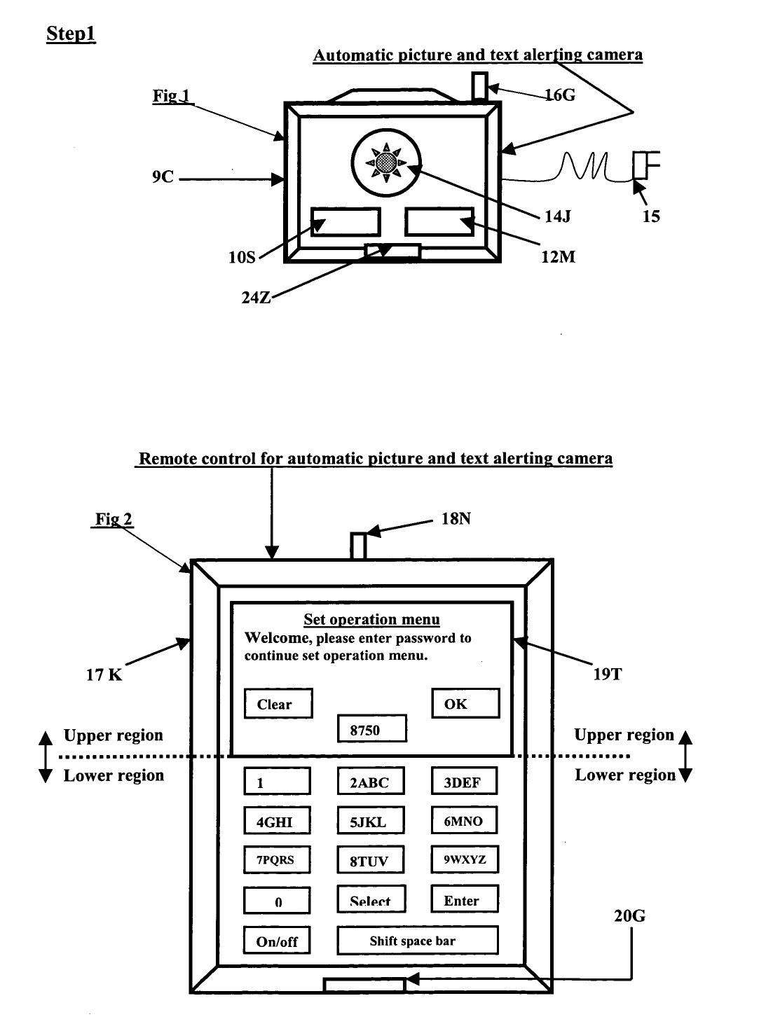

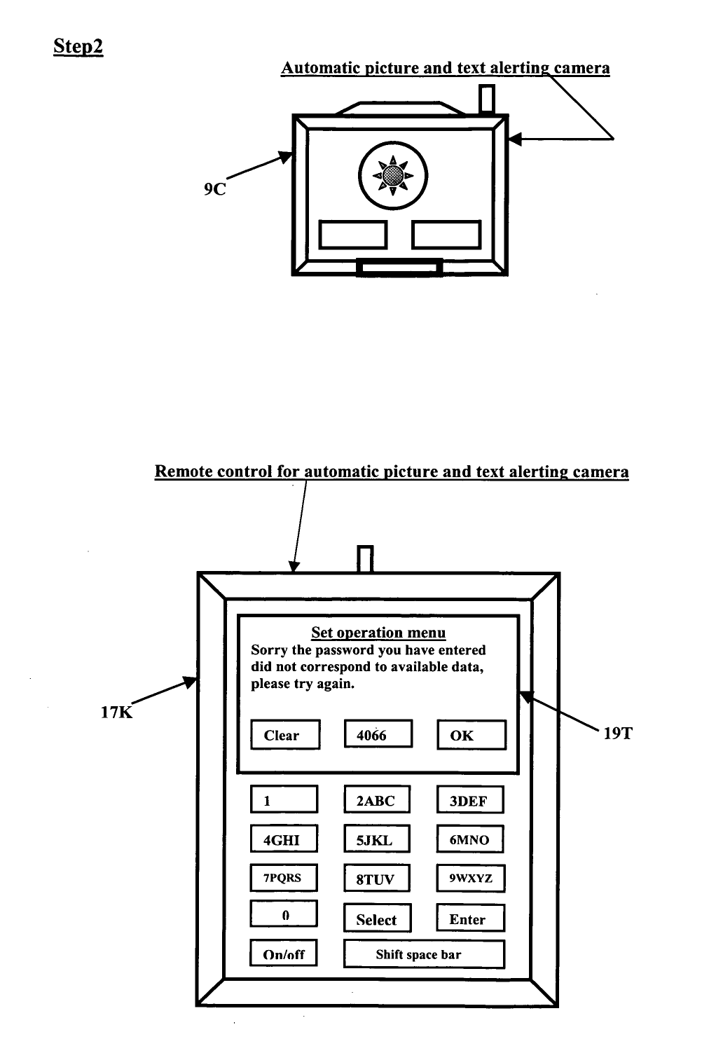

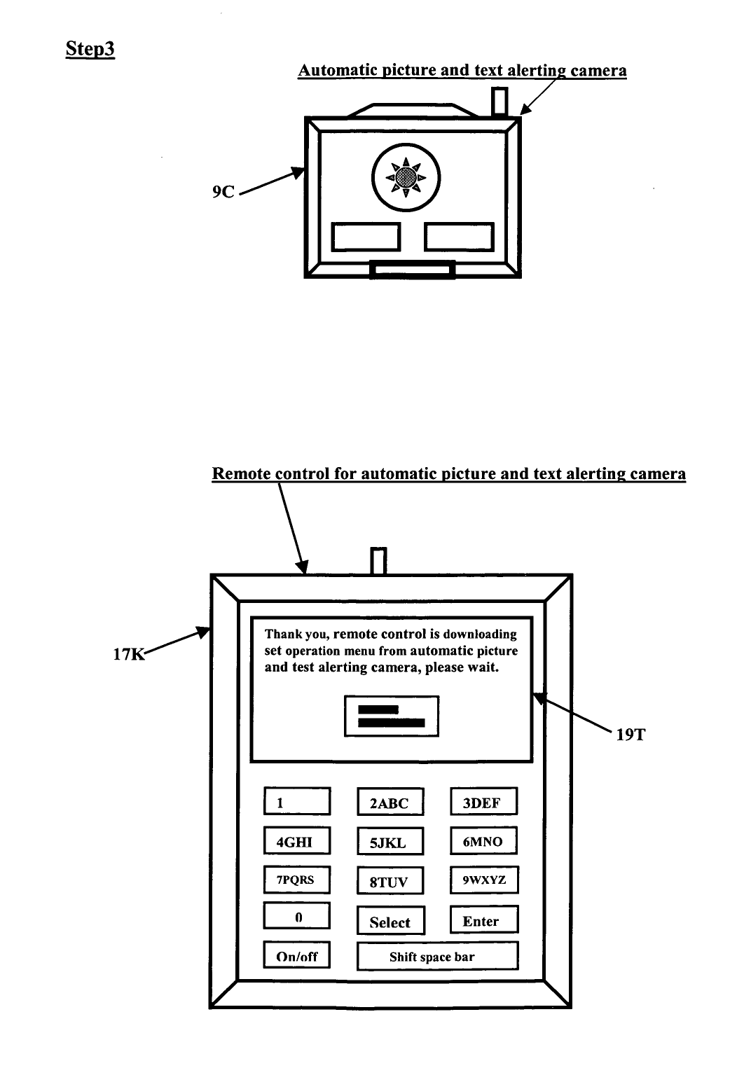

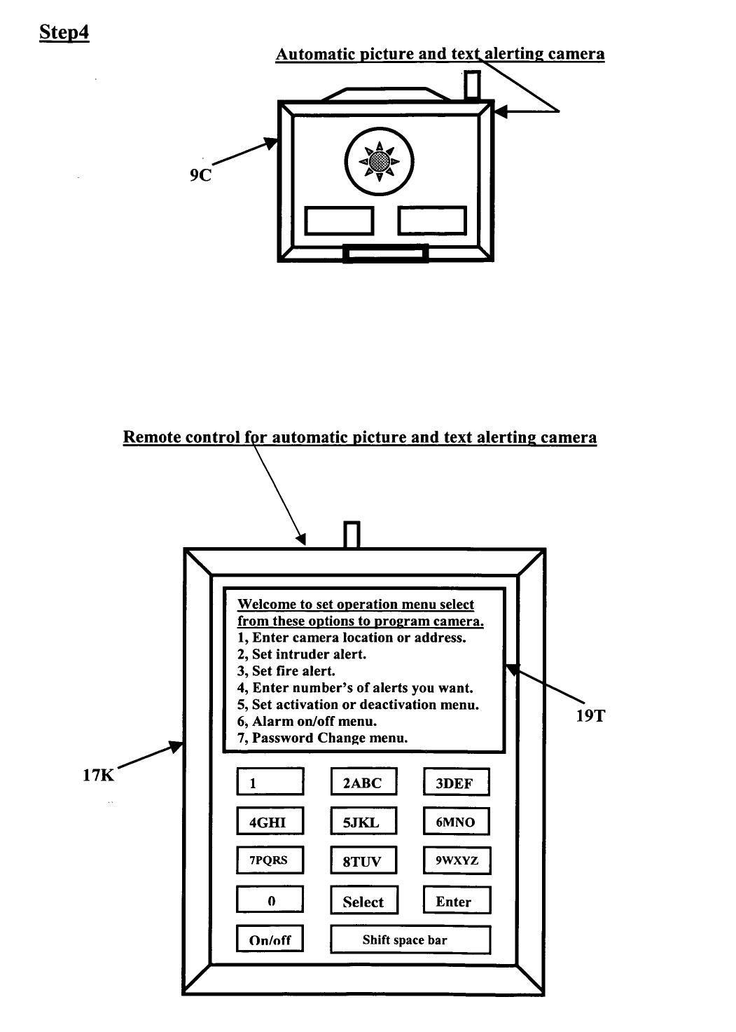

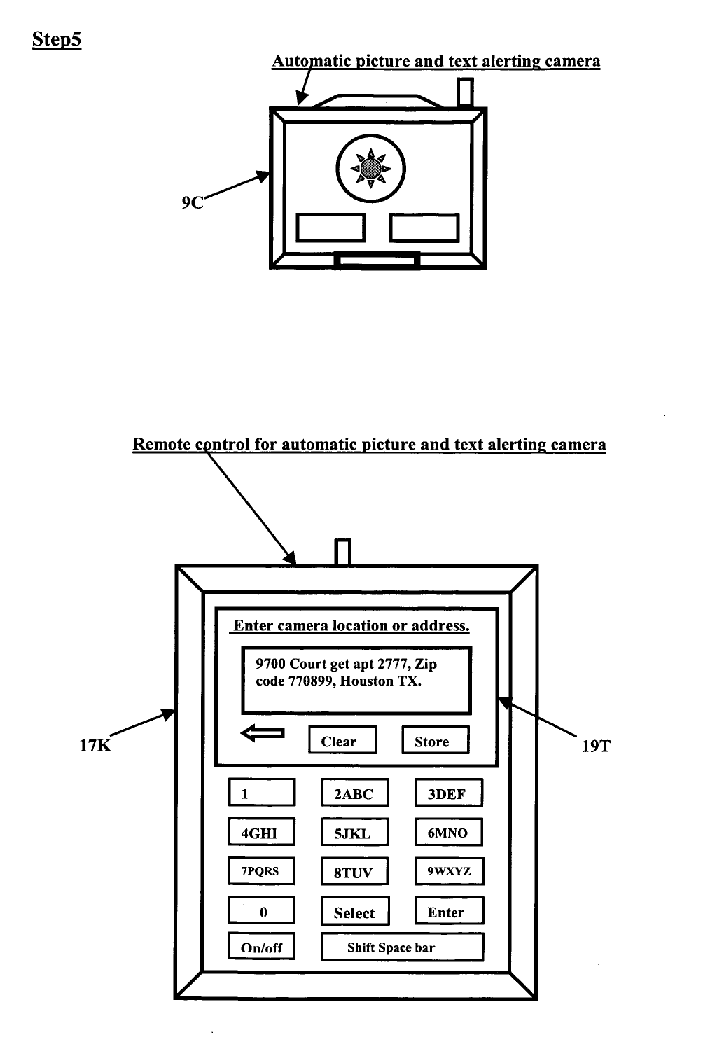

Step 1 shows FIG. 1 of 1 is the embodiment of the camera 9C and it is a desktop or wall mounted camera 9C with an inbuilt smoke detector 10S and an inbuilt motion detector 12M. The camera 9C comes as a wireless network camera; an AC power supply or a battery can power the camera 9C, here is the camera 9C AC cord 15. FIG. 2 of 1 is the embodiment of the remote control 17K, the remote control 17K comes as a wireless remote control and with the following features, some set of key pads located in the lower region of the remote control 17K numbered 0 to 9 also the key pad or buttons are lettered from 2 to 9 the letter A to Z, other buttons or key pads alas located in the lower region of the remote control 17K are, select button, an enter button and a shift space bar button, the remote control also come with an L, C, D liquid crystal display 19T, the remote control is powered by inserting a 9 volt battery compartment 20G. The smoke and intrusion detector in the camera 9C is design to detect any outback of smoke or fire or intrusion in the area were the camera 9C was installed and automatically activate an electronic circuit that is made up of one or more microprocessor and some other special electronic component like memory chip, transistors, diode, capacitor, and more all in the camera 9C, all this component work together to send the picture detected through a lens 14J in the camera 9C to any programmed wire/wireless cellular telephone (number) automatically.

The set of keypads labeled 0 to 9 and AtoZ in the remote control is use for entering cellular telephone number or numbers, the key pads is also use for entering password for operation the camera, further more the key in buttons or key pads is use for entering alphabet example of the alphabet enter is the address or location were the camera 9C is installed, the key in button or key pads are touch tone pads or buttons. The select button located in the lower region in the remote control 17K is use for selecting programs displayed on a liquid crystal 19T in the remote 17K, a selected option are automatically highlighted and it is automatically stored or finally selected or enter with the use of the enter button or key pads. The Shift space bar button or keypad is use for making space between alphabets, when the user enters alphabets or letters e.g. the address/location of the camera 9C. All information selected and enters by the user using the remote control 17K, are automatically sent to the camera 9C, because the remote control 17K works as a transceiver and the remote control 17K can work as a master remote control 17K because it can be made to operate one or more automatic picture and text alerting camera 9C.

The remote control 17K displays some program or menu this program or menu are use in controlling the camera 9C and they are elaborated from step 1 to 11, step 1 show FIG. 1 the embodiment of the camera the camera 9C comes with an inbuilt motion detectors 12M and smoke detector 10S mounted in the housing of the camera 9C. Also in step 1 the remote control FIG. 2 17K displays some text instruction and some option named clear and ok in a liquid crystal 19T, the text is instructing the user what to do as soon as the on/off button located at the lower end of the remote is activated to turn on the remote, the liquid crystal 19T in the remote control 17K displays set operation menu in this menu the user is welcome and instructed to enter password to continue set operation menu, the password is a four digit password that was set by the user or the manufacturer if the rough password is enter by the user using the key in buttons or key pads and the ok option is selected using the select and enter buttons the remote control automatically displays step 2.

Reference is made to step 2 in continuation of step 1 the liquid crystal 19T in the remote control 17K displays another instruction in step 2 telling the user Sorry the password you have entered did not correspond to available data, please try again. This said date is the password encoded to unlock the operating menu downloaded by the remote control 17K from the camera. If the user enters the right password and the ok option displayed on the liquid crystal is selected using the select and enter buttons the remote control 17K automatically displays step 3.

Reference is made to step 3 in continuation of step 2 the liquid crystal 19T in the remote control 17K displays another instruction in step 2 telling the user thank you, remote control 17K is downloading set operation menu from automatic picture and test alerting camera 9C, please wait. And two dark bars will appear in the liquid crystal 19T, when the two dark bars, becomes equal the remote control automatically displays step 4, it only take a few seconds for the two dark bars to become equal indicating a complete download of the operation menu from the remote control 17K.

Reference is made to step 4 in continuation of step 3 the liquid crystal 19T in the remote control 17K displays another instruction in step 4 telling the user welcome to set operation menu select from these options to program camera 9C. In this menu a list of option is displayed on the liquid crystal 19T in the remote control 17K and the user is instructed to select from the option or programs listed, here are the names illustrating the programs in step 4, (1) Enter camera location or address. (2) Set intruder alert. (3) Set fire alert. (4) Enter number's of alerts you want. (5) Set activation or deactivation menu. (6) Alarm on/off menu. (7) Password change menu. This option or programs are selected by the user to set or operate the camera 9C using the select and enter button in the remote control 17K, the remote control 17K work as a transceiver sending and receiving information to and from the camera 9C. This programs and options is describe one after another from step 5 to step 11.

Reference is made to step 5 in continuation of step 4 the liquid crystal 19T in the remote control 17K displays another instruction in step 5 and it is the eternal view of menu or program number (1), the instruction in program number (1) tells the user to enter camera 9C location or address. With the use of the key in buttons or key pads labeled A to Z and the select and enter buttons the user can enter the exact location were the camera 9C will be installed which can be his or her home address or office, or room, and with the shift Space bar button located also in the lower region of the remote control 17K the user can space or shift letters or alphabets entered in other for the letters to make sense to a reader. After the user have finished entering the location or address of the camera 9C, the user should select store in other for the remote control 17K to send the location or address to the camera 9C for storage, if the user decide to change the location of the camera 9C the user can select clear from the option display on the liquid crystal 19T and re-enter a new location or address using the key pads in remote control 17K, the address or location of the camera 9C entered by the user is display on the liquid crystal before it is sent to the camera 9C for storage. An arrow indicating left is also displayed in the liquid crystal 19T in the remote control 17K the arrow can be selected and enter by the user if the user decides to go back to step 4, using the select and enter button in the remote 17K the user can select the arrow.

Reference is made to step 6 in continuation of step 4 the liquid crystal 19T in the remote control 17K displays another instruction in step 6 and it is the eternal view of menu or program number (6), the menu or program displayed say enter number for intruder alert, and also an instruction is displayed in program number (6) telling the user to enter his or her cell phone number or any other preferred cellular telephone number for automatic emergency picture and text alert, the user can enter his or her cellular telephone number or any other party e.g. the police or any other party the user want the automatic picture and text camera 9C to send picture of intrusion merge with the text message telling the address of the camera 9C when emergency is detected by the motion detector in the camera 9C, this only happens when the camera 9C is set by the user to alert by sending the picture and the text telling address or location of the camera 9C which is also the address of the emergency. FIG. 3 show example of any wireless cellular telephone that can receiver picture and text and how the picture of the intruder and the text message telling the location or address of the emergency sent by camera 9C may appear in the cellular telephone, apart from the text telling emergency and the alphabets telling the exact location of the emergency some numbers are automatically displays along with the picture and the text, this is called the provider code or number. Example of the provider code is displayed 881447 in the alerted cellular telephone; the code is use by any alerted party like the police or fire service, when any false alert is sent by any user, false alert include rough address or false emergency alert. All the police or the fire service need to do is to send the provided code to the provider and the provider will use the provider code or number to fish out the owner of the automatic alerting camera 9C, the provider code appear weather the camera 9C is set to alert when fire or intrusion is detected the motion detector 10S and smoke detector 12M in camera 9C. Another way the own of the camera 9C can be identify can be in form of caller id or network number just like a telephone number, that can equality be sent by the camera to the alerted cellular telephone.

Reference is made to step 7 in continuation of step 4 the liquid crystal 19T in the remote control 17K displays another instruction in step 7 and it is the eternal view of menu or program number (7), the menu or program displayed, say enter number for fire alert, and also an instruction is displayed in program number (7) telling the user to enter his or her cellular telephone number or any other preferred cellular telephone number for automatic emergency picture and text alert, the user can enter his or her cellular telephone number or any other party e.g. the fire service or any other party the user want the automatic picture and text camera 9C to send picture of outbreak of fire and the text message telling the address of the camera when emergency is detected by the smoke detector 10S in the camera 9C, this only happens when the camera 9C is set by the user to alert by sending the picture and the text telling emergency and address or location of the camera 9C which is also the address of the emergency. FIG. 3 show example of any wireless cellular telephone that can receiver the picture and text, and how the picture of the fire and the text message telling the location or address of the emergency sent by the camera 9C may appear in the cellular telephone.

Reference is made to step 8 in continuation of step 4 the liquid crystal 19T in the remote control 17K displays another instruction in step 8 and it is the eternal view of menu or program number (8), the menu or program displayed, says enter numbers of alerts you want, in the is menu the users is instructed Select and enter the numbers of alerts he or she want from the listed options, with the use of the select and enter button the user can select from the number, times he or she want the automatic picture and text alerting camera 9C to send picture and text when any emergency is detected by any of the detectors, some numbers are displayed in the liquid crystal 17K in the remote control 9C they are 1, 2, 3, 5, 10, a selected number is automatically highlighted and the user should select ok using the select and the enter button in other to set or store the number of alerts selected, if the user want unlimited alert the user can contact the provided because the camera can also be set by the provider from the provides station to alert at any number of times.

Reference is made to step 9 in continuation of step 4 the liquid crystal 19T in the remote control 17K displays another instruction in step 9 and it is the eternal view of menu or program number (9), the menu or program displayed are Set activation or deactivation menu, in the menu the user is instructed to select from the listed options to activate or deactivate the camera 9C alerting mode, with this menu the user can activate or deactivate the camera 9C alerting mode when exiting or entering the premises were the camera 9C is located with the use of the select and enter button the user can select from the options display in the liquid crystal 19T and enter to apply a particular option, the ok is selected and entered with the use of the select and enter button in the remote control 17K, the activate option if selected by the user, enable the camera 9C to sent picture and text to any programmed cellular telephone (number) entered by the user why the deactivate option disable the camera 9C from sending picture or text in the is in the premises were the camera 9C is located.

Reference is made to step 10 in continuation of step 4 the liquid crystal 19T in the remote control 17K displays another instruction in step 10 and it is the eternal view of menu or program number (10), the menu or program displayed are alarm on/off menu, in the menu the user is instructed to select from the listed options to put on or off camera 9C alarming mode. With this menu, the user can set the alarm 24Z in the camera to sound or not to sound when any emergency is detected by selecting from the options in condition 1, condition 2 enable the alarm 24Z to sound or not to sound when the camera 9C is not set to send picture and text. The options in condition 1 and 2 are on or off and are selected by the user using the select button in the remote control 17K and the selected options is applied by the user by selecting ok.

Reference is made to step 10, and is in continuation of step 4 the liquid crystal 19T in the remote control 17 displays another instruction in step 10 and it is the eternal view of menu or program number (10), the menu or program displayed are password change option, in the menu the user is instructed to enter four digit number, then select ok to apply as your new password, or select clear to cancel a rouge entry, the user only make use of this menu if he or she decide to create a new password for operating the camera 9C. When the user have finish entering any four digit pass word the user should select ok to apply the new password as operation menu password, if the user decide to cancel his or her entering the user can select clear to delete or cancel a rough entering.

All options selected and enter in the remote 17K control is automatically sent to the camera 9C by the remote 17K, the remote control 17K is a wireless electromagnet-tic remote control and work with-in 100 meter or more around the region were the camera 9C is located.

Reference to step 12 shows FIG. 4 the electronic block diagram of the remote control. Here is the key pads 107 the key pads are link to the keypads decoding circuits 104, the keypads decoding circuits 104 function to detect any number or alphabet enter by the user using the keypads 107, the keypads decoding circuit 104 is made up of one or more logic gate or integrated circuit. The keypads decoding circuits 104 is connected to a microcontroller 103, the microcontroller 103 function in controlling the logic display circuits 102 and the transceiver 101. The logic display circuits 102 function in decoding any program, number or text generated or downloaded by the microcontroller 103.

The microcontroller also download and sent data to and from the automatic picture and text-alerting camera by connecting to the transceiver 102 circuit, information generated and downloaded by the microcontroller 103 is displayed on the liquid crystal by the help of the logic display circuit 102. All this segments function together to make the remote control work, the remote control start functions, when a 9-volt battery is connected to the battery compartment in the remote control.

Reference to step 13, FIG. 5 is the electronic block diagram of the camera, here is the smoke detector 10S and the motion detector 12M in the camera. The transceiver 203 plays an important roll by sending and receiving data from the remote control. The address or location of the camera, enter by the user using the key pads in remote control, is receiver by the transceiver, and it is processes by the microprocessor 209, and store by the memory 207. When any emergency is detected by smoke detector 10S or motion detector 12M the network connecting circuit will automatically be trigger by the microprocessor, and at the same time the microprocessor also trigger the Picture detecting circuit, and the picture detecting circuit automatically process any picture captured by the lens 14J in the camera. The picture detecting circuit 205 also starts preparing the picture to be sent to one or more program cellular telephone number programmed by the user using the remote control. Moreover, at the same time, the picture detecting circuit is preparing to send the picture; the text regenerating circuit automatically starts generating the address or location of the camera store in memory 207. The address or location was entering by the user using the remote control 202, and text telling the location or address is retrieved from the memory 207 by the text regenerating circuit, additional information not enter by the user is also retrieve from the memory the text telling emergency depending on the emergency condition that is detected. The picture and the text messages is automatically sent to the picture and text merging circuit 201, the picture and the text will be merge by the picture and text merging circuit 201 and both the text and the picture, will be sent to the network connecting circuit 208. In addition, the network connecting circuit will automatically send out the picture merging with the text, by means of any available telecommunication network or provider, to be received by any program cellular telephone (number) that can receive the emergency picture merging with text message, all the functions occurs in less then 10 seconds or more. Here is the alarm; the alarm can be made to generate one on more alarming tones, the alarm can be built with transistors or an integrated circuit, the camera can be built with surface mount or thru hole integrated circuits and other special component such as resistor, transistors, light emitting diode, capacitor, diode and more and star working when the AC power circuit 204 is connected to AC power supply. For any further features in camera is analyze from step 1 through 13.

1. I claim a network camera that is easily programmed by the user to disclose the exact emergency condition and the location of the emergency by sending picture of the emergency and some text message merge with the picture automatically to any programmed cellular telephone of the user choice.

2. The camera instrument of claim wherein said is fully equipped with an inbuilt motion and smoke detector, the camera is specially design to capture any emergency condition detected by any of the said inbuilt detectors, and automatically send the picture of the emergency along with some text massage merge to the picture stating the address of the emergency, this information is sent by the camera to one or more programmed wireless cellular telephone (number) that can receive the picture and the text massage.

3. The camera instrument of claim also comes with an external remote control, the remote control is specially design for operating the camera,

4. The remote control of claim, act as a transceiver by sending and receiving data (program) to and from the camera.

5. The remote control of claim has some set of buttons use for entering number or alphabets.

6. The remote control of claim is use for programming activating or deactivating the camera.

7. The camera instrument of claim is a wireless camera.

8. The remote control of claim is a wireless remote control

9. The camera instrument of claim has an alarm that can be set to sound when the camera is set to send picture and text message of an emergency to any programmed cellular telephone number, the alarm can also be set to sound when the camera is not set to send picture with text, the alarm can also be put off completely.

10. The camera instrument of claim can be set to alert by sending picture with text one or more times.

11. The camera instrument of claim has means that the user can enter alphabetical letters telling the location or address of the camera using the remote control.

12. The camera instrument of claim can be battery powered or an AC powered

13. The remote control of claim is a battery-powered remote control.

14. The remote control of claim has some set of buttons therein said are use for selecting or entering programs displayed on a liquid crystal in the remote control.

15. The picture sent by the said camera can be a motion or a still picture.
